(19) United States
(12) Patent Application Publication
(10) Pub. No.: US 2018/0056805 A1
(43) Pub. Date: Mar. 1, 2018

(54) Method of Energizing Electric Vehicle Power Train with Multiple and Independently Controlled Battery Packs

(71) Applicants: Fang Shen, San Jose, CA (US); Hua Shui, Shanghai (CN); Jie Chen, Shang Hai (CN)

(72) Inventors: Fang Shen, San Jose, CA (US); Hua Shui, Shanghai (CN); Jie Chen, Shang Hai (CN)

(21) Appl. No.: 15/249,356

(22) Filed: Aug. 27, 2016

(51) Int. Cl. B60L 11/18; H02J 7/00

(52) U.S. Cl. CPC B60L 11/1864; H02J 7/0045; B60L 11/1822; B60L 11/1861; H02J 7/0026

(57) ABSTRACT

This invention provides a method of energizing electric vehicle (EV) power train with multiple and independently controlled battery packs. In this method, an EV can have one or more battery packs installed, only limited by the EV's physical spaces of the battery pack connector. All battery packs are interchangeable. Each battery pack has its battery management system (BMS) software and can either provide energy to the EV concurrently or individually. A typical embodiment of the invention comprises of a battery pack controller, a battery pack connector, a battery pack acting as the master (master battery pack), and optional slave battery pack(s). The battery pack controller connects electronically with the battery pack connector. The master battery pack, and optional slave battery pack(s) are mounted in the modular battery pack connector. The battery pack controller whose source is from the BMS of the master battery pack manages the charging and discharging of the master battery pack and optional slave battery pack(s).

### FIELD OF THE INVENTION

The present invention relates to the field of electric vehicle technology, whose power train is energized by one or multiple battery packs.

### BACKGROUND

While electric cars are gaining more popularities, electric vehicle mileage has also been the most important concern for consumers because of their limited driving range stemming from their limited battery energy, which is further exacerbated by the weight of the vehicle.

Meanwhile, electric vehicle charging facilities are lacking and charging speed is also a concern. As a result, there is a great need and market to have the ability to increase the electric vehicle driving ranges by consumers themselves.

The present invention allows flexibility of mounting the right number of battery packs depending on the needs of planned distance and weight of electric vehicle.

### STATE OF ART WORK

An electric vehicle normally has three major parts in its power train:
1. One or multiple electric motors(1 in FIG. 1)
2. One or multiple motor driver controllers (2 in FIGS. 1), and
3. One Battery Pack (3 in FIG. 1).

The battery pack (3 in FIG. 1) is normally installed in one battery enclosure box.

Sometimes the battery pack (3 in FIG. 1) can be installed in multiple battery enclosure boxes. But these boxes will operate as one battery pack, which means that individual boxes have to be connected together to energize the EV's power train under one BMS control to charge/discharge together. The formation of an individual battery pack is shown in FIG. 4, where a single battery pack is formed normally by connecting multiple battery modules (1 to 4 in FIG. 4) and all battery modules to be connected together so to operate together as one battery pack, managed by one Battery Management System (7 in FIG. 4) and one control unit (5 in FIG. 4) and a Charger/Discharger Port (6 in FIG. 4). In short, all battery modules function together as a single battery pack.

### DESCRIPTION

This invention relates to an EV with a Power train comprising with multiple and independently controlled battery packs (FIG. 2.).

Embodiments of the present invention comprises of a battery pack controller, the modular battery pack connector, a master battery pack that is a battery pack mounted in the designated space in the modular battery pack connector for master battery pack, and optional slave battery packs. The master battery pack, and optional slave battery packs are equipped with their own battery management system.

Embodiments of the present invention has the battery pack controller controlling the charging and discharging of the master battery pack and slave battery pack(s).

An example embodiment of the present invention comprises multiple battery packs energizing the EV power train shown in FIGS. 2 and 3 with one electric motor (1 in FIGS. 1, and 1 in FIG. 2), one motor driver controller (2 in FIGS. 1, and 2 in FIG. 2), and multiple battery packs (4 to 7 in FIGS. 2, 3 to 7 in FIG. 3).

In the embodiments of the present invention, the battery pack controller directs discharging from the master battery pack, or combined discharge from the master battery pack and slave battery packs.

In the embodiments of the present invention, the battery pack controller directs charging to the master battery pack and the slave battery packs. The slave battery packs can also be charged externally in the present invention.

In the embodiments of the present invention, the battery pack controller directs balance operation by redistributing energy between battery packs including both the master and slave battery packs when they are mounted on the battery pack connector.

In the embodiments of the present invention, the battery pack controller directs balance operation by redistributing energy between the battery modules and cells within a battery pack mounted on the battery pack connector.

In the embodiments of the present invention, the battery pack controller is formed from the promotion of the master battery pack or setup external to the master battery pack.

In the embodiments of the present invention, the slave battery packs can be mounted on any of the open space on the battery pack connector except the designated space reserved for the mater battery pack.

In the embodiments of the present invention, both the master and slave battery packs can be removed or inserted without regards to the switch status of the master battery pack and slave battery packs.

In the embodiments of the present invention the state of charge of the master slave battery packs can be displayed on its own display or the EV display device.

In the embodiments of the present invention, the battery pack connector will prevent insertion of the master battery pack or the slave battery packs when the polarities of the insertion is wrong.

### BRIEF DESCRIPTION OF THE DRAWINGS

FIG. 1 shows a state of art architecture of an EV power train, and the relations of a motor/drive controller, a battery pack, and EV motor in the typical EV power train system.

FIG. 2 shows a schematic diagram of the invention with the implementation of connection structure for electric vehicles power train with multiple battery packs, as well as the relations of an EV motor, a motor controller driver and multiple battery packs.

FIG. 3 shows a schematic diagram of the invention with the implementation of connection structure for battery packs. FIG. 3 indicates the relations of the battery pack controller, multiple battery packs including one master battery pack and several slave battery packs, and battery pack connector.

FIG. 4 shows an example schematic diagram of the implementation within one battery pack in the state of art of EV power train system. FIG. 4 shows the relations of BMS, Unit controller and battery modules.

### DETAILED DESCRIPTION OF FIGURES

In the following detailed description, numerous specific details are set forth in order to provide a thorough understanding of the invention. The invention is not intended to be limited to the particular embodiments shown and described.

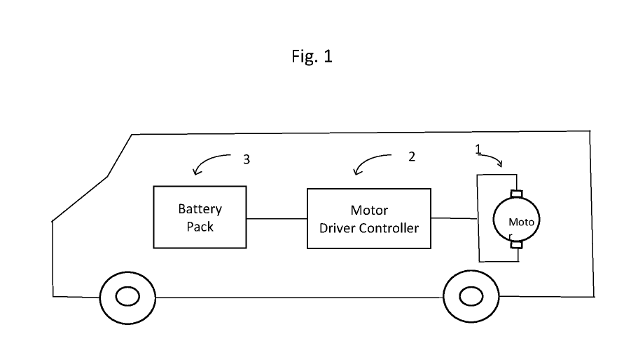

Referring to FIG. 1, in the current application, EV motor 1 is connected to the motor drive controller 2. In another embodiment, the motor depicted in 1 can be multiple motors for front and back transmission.

Referring to FIG. 1, the motor drive controller 2 is connected to the battery packs 3 and EV motor 1.

Referring to FIG. 1, the battery pack 3 is connected to the motor drive controller 2.

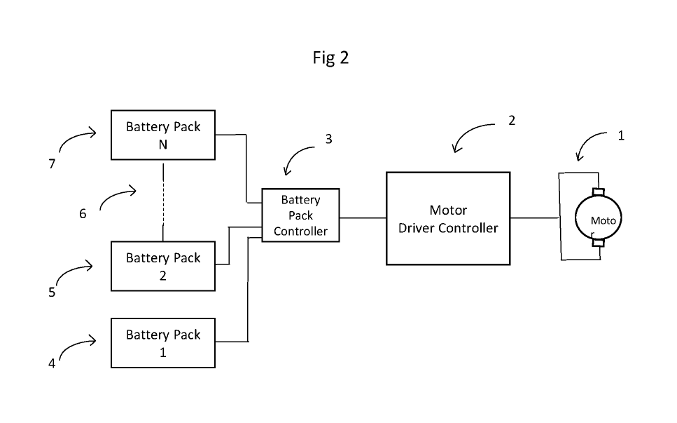

Referring to FIG. 2, in one embodiment, EV motor 1 is connected to the motor drive controller 2.

Referring to FIG. 2, in one embodiment, the motor drive controller 2 is connected to the battery pack controller 3.

Referring to FIG. 2, in one embodiment, the battery packs 3 to 7 are connected to the battery pack controller 2. N in 7 means any undetermined integer number large than 2.

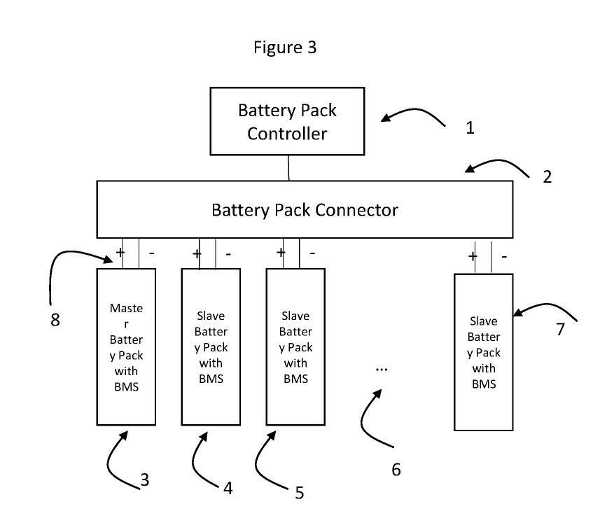

Referring to FIG. 3, in one embodiment, the battery pack controller 1 is connected to the battery pack connector.

Referring to FIG. 3, in one embodiment, the software in the battery pack controller 1 is sourced from the BMS software of the master battery pack. In another embodiment, the software in the battery pack controller 1 is sourced externally from the interface of the battery pack controller.

Referring to FIG. 3, in one embodiment, the battery pack connector 2 allows connection of a master battery pack and slave battery packs.

Referring to FIG. 3, in one embodiment, the master battery pack 3 is connected to the battery pack connector using the master battery pack position in the battery connector 8. The master battery pack has its own battery management system software.

Referring to FIG. 3, in one embodiment, the slave battery pack 4 is connected to the battery pack connector using one of the slaver battery pack position. The slaver battery pack 4 has its own battery management system software.

Referring to FIG. 3, in one embodiment, the slave battery pack 5 is connected to the battery pack connector using one of the slaver battery pack position. The slaver battery pack 5 has its own battery management system software.

Referring to FIG. 3, in one embodiment, the dots 6 indicate that there are many slave battery pack positions depending on the physical dimension of the battery pack connector.

Referring to FIG. 3, in one embodiment, the slave battery pack 7 is connected to the battery pack connector using the last slaver battery pack position. The slaver battery pack 7 has its own battery management system software.

Referring to FIG. 3, the battery connector 8 prevent installation of a battery pack into the master battery slot or the slave battery slot if the polarity of insertion is incorrect.

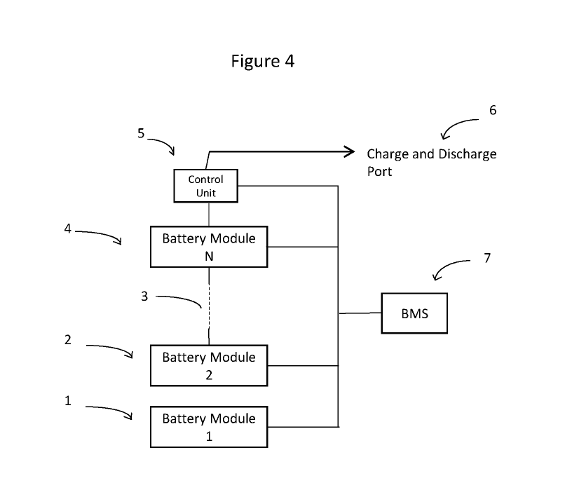

Referring to FIG. 4, it shows a battery pack comprises multiple battery modules, all under the control of a single BMS and battery unit control. FIG. 4 shows an example schematic diagram of the implementation within one battery pack in the state of art of EV power train system.

The above embodiments are for illustrative purposes and characteristics of the technical concept of the present invention and are not intended to limit the present invention, any modifications within the spirit and principles of the present invention, made, equivalents, etc., should be included in the scope of the present invention.

1. A method of energizing electric vehicle (EV) power train with multiple and independently controlled battery packs.

2. The system of claim 1 wherein the battery packs can be charged concurrently or independently when they are mounted on the EV under the control of the battery pack controller (3 in FIG. 2.).

3. The system of claim 1 wherein these battery packs can be discharged concurrently or independently when they are mounted on the EV under the control of the battery pack controller (3 in FIG. 2.).

4. The system of claim 1 wherein these battery packs can be mounted on the EV regardless of these battery pack's state of charges.

5. The system of claim 1 wherein each of these battery packs can be removed from the EV regardless these battery pack's state of charges.

6. The system of claim 1 wherein the master battery pack can be controlled to provide output independently and concurrently of the slave battery pack(s).

7. The system of claim 1 wherein the slave battery pack(s) can be controlled to provide output independently and concurrently with the master battery pack.

8. The system of claim 1 wherein the mater and slave battery packs can be controlled to provide balance operation between each packs.

9. The balance operation of claim 8 means the energy redistribution between battery cells in a battery pack and between all mounted battery packs.

10. The system of claim 1 wherein a battery pack can be placed in any of the open spaces (4 to 7 in FIG. 2) in the battery pack connector.

11. The system of claim 1 wherein the battery pack placed in the designated space for the master battery pack is functionally treated as the master battery pack.

12. The system of claim 1 wherein the battery pack controller (3 in FIG. 2. and 1 in FIG. 3.) is either provided by the BMS from the master battery pack or set up from external source.

13. The system of claim 1 wherein the state of charge of the individual battery pack or the sum of all battery packs is displayed on its own display or on the EV display.

14. The system of claim 1 wherein the battery pack connector (8 in FIG. 3) will prevent insertion of any battery pack when the battery pack is inserted in the wrong polarity.
